(19) United States
(12) Patent Application Publication
(10) Pub. No.: US 2021/0170360 A1
(43) Pub. Date: Jun. 10, 2021

(54) CONDUCTIVE POLYMER GRAFTED REUSABLE 3D PLATFORM FOR WATER RESTORATION

(71) Applicant: THE REGENTS OF THE UNIVERSITY OF CALIFORNIA, Oakland, CA (US)

(72) Inventors: Jennifer Lu, Merced, CA (US); Wenxin Fu, Merced, CA (US)

(73) Assignee: THE REGENTS OF THE UNIVERSITY OF CALIFORNIA, Oakland, CA (US)

(21) Appl. No.: 17/139,813

(22) Filed: Dec. 31, 2020

Related U.S. Application Data
(63) Continuation of application No. PCT/US2019/044091, filed on Jul. 30, 2019.
(60) Provisional application No. 62/712,008, filed on Jul. 30, 2018.

(51) Int. Cl. B01J 20/20; B01J 20/26; B01J 20/28; B01J 20/32; C02F 1/461; C02F 1/467

(52) U.S. Cl. CPC B01J 20/205; B01J 20/262; B01J 20/265; B01J 20/28011; B01J 20/28033; B82Y 30/00; B01J 20/3272; B01J 20/3219; B01J 20/3295; C02F 1/46109; C02F 1/4678; B01J 20/3204

(57) ABSTRACT

A platform and system for concentration, reduction and regeneration of heavy metals and other contaminants from fluids is provided. The platform has a three-tiered hierarchical porous structure, composed of micropores formed by woven carbon cloth, nanopores formed after carbon nanotube growth on the cloth fibers and mesopores formed by a polymer outer layer. The material of the platform can be incorporated into cells with two electrodes with properly functionalized PDAN grafted 3D carbon as an anode and cathode respectively. Metal ions and toxic anions in water will be captured selectively by primary amine, secondary amine and quaternary amine groups in porous PDAN on the anode. Metals are captured and reduced by the cathode.

### CROSS-REFERENCE TO RELATED APPLICATIONS

This application claims priority to, and is a 35 U.S.C. § 111(a) continuation of, PCT international application number PCT/US2019/044091 filed on Jul. 30, 2019, incorporated herein by reference in its entirety, which claims priority to, and the benefit of, U.S. provisional patent application Ser. No. 62/712,008 filed on Jul. 30, 2018, incorporated herein by reference in its entirety. Priority is claimed to each of the foregoing applications.

The above-referenced PCT international application was published as PCT International Publication No. WO 2020/028334 A1 on Feb. 6, 2020, which publication is incorporated herein by reference in its entirety.

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### STATEMENT REGARDING FEDERALLY SPONSORED RESEARCH OR DEVELOPMENT

This invention was made with Government support under NNX15AQ01A awarded by the National Aeronautics and Space Administration. The Government has certain rights in the invention.

### BACKGROUND

### 1. Technical Field

This technology pertains generally to water decontamination methods and more particularly to a 3D heavy metal separation platform that can absorb harmful cations or anions in waste water or groundwater for water restoration as well as recycling the collected heavy metals efficiently. The system apparatus uses an electrochemically regeneratable platform with a conductive hierarchical 3D electrode that offers three tiered (macro-, micro- and nano-scale) continuous porous structures with minimum tortuosity. The platform is capable of removing all soluble Hg species as well as other heavy metal species from water, for example.

### 2. Background Discussion

Millions of gallons of waste water are produced annually by industrial plants, gas and oil production and mining operations. Much of this waste water contains heavy metals that are harmful to the human body, such as mercury, cadmium, lead, zinc, copper and chromium. Consequently, mandatory requirements controlling metal levels in waste water to below prescribed concentrations have been established in most parts of the world. The removal of heavy metals is also an important aspect of community water treatment plant processing of water for public consumption.

Heavy metals such as mercury (Hg) in waste water may be present in several different forms including ionic, organic, elemental and particulate forms that greatly increase the complexity of removal efforts. For example, elemental mercury may be oxidized and converted to water soluble mercurous or mercuric salts as a byproduct of various industrial processes.

Accordingly, various water treatment processes have been developed for the removal of heavy metals from waste water. One commercial technology available for treating mercury in water is a neutralizing coagulation and sedimentation process where an alkaline neutralizing agent is added to convert heavy metal ions into their hydroxides, which are then are coagulated and precipitated out with a flocculant. However, the neutralizing coagulation and sedimentation processes produce large volumes of metal hydroxide sludge that is difficult to transport and store. This sludge may also be the source of secondary pollution depending on the method of disposal because it may be dissolved back into solution again.

Another approach uses a metal scavenger to cause the metal ions to become insoluble and precipitate out allowing their removal from the water. Chemical precipitation may also occur by raising the pH to a neutral or alkaline level to precipitate out the heavy metals as metal hydroxides. However, metal hydroxide precipitation is usually not effective enough to reduce heavy metal levels below typical discharge limits and metal ions that have chelated will not precipitate at all.

Other approaches facilitate a reaction with organic or inorganic sulfides. These approaches have been used to produce metal sulfides that will convert dissolved metal ionic species into a water insoluble, form. However, sulfide precipitation produces very fine colloidal particles that are hard to remove from the water stream.

Ion exchange resins have also been used to remove different heavy metal ions from contaminated water. Conventional ion exchange resins usually come in the form of comparatively large spherical gels with particle diameters in the tens of micrometers. Contaminated water is passed through the gels and heavy metal ions present in the water are adsorbed on the gels due to the diffusion equilibrium of the ions between the water and the interior of the gel particles. It is therefore necessary to use large quantities of exchange resins to be effective and the flow rate of contaminated water must be controlled to prevent the bypass of metal ions through the gels.

To improve the collection efficiency, conventional columns incorporating high surface area nanostructures, such as activated carbon and carbon nanotubes (CNTs), have been investigated. These material systems have been demonstrated to be effective in the advanced treatment of Hg polluted water to some extent. However, the column materials are difficult to regenerate and leaching of nanomaterials into water causes secondary pollution.

Adsorbents offer a useful approach to address mercury (Hg) contamination in aqueous solutions, and a variety of adsorbent technologies have been developed. In particular, nanotechnology enabled adsorbents offer extremely large surface areas for adsorption. However high tortuosity that is the result of ill-defined porous structures retards mass diffusion in real-world applications. Furthermore, lack of strong affinity to certain Hg species, especially CH₃Hg⁺, often render adsorbents ineffective.

The chemistry of Hg offers avenues to target its surface adsorption. Hg in the +2 valence state (e.g. Hg²⁺ and CH₃Hg⁺) is a soft Lewis acid that preferentially bonds with soft Lewis bases. Thus, ligands such as sulfur-containing groups have been widely used to attract Hg. Sulfur-functionalized magnetic nanoparticles have been found to effectively sequester Hg²⁺ from water. These nanoparticles are more easily collected than precipitates or colloids. However, these nanoparticles have not been reported to be able to effectively capture organic Hg or CH₃Hg⁺ for example.

Alternatively, Hg²⁺ and CH₃Hg⁺ can both form complexes with nitrogen compounds including amines and amino acids, a tendency which is responsible for Hg uptake into biological species. Reports show that —NH₂ functionalized CNTs can effectively adsorb CH₃Hg⁺. Likewise, N-containing polymers such as polyaniline, PANI, polypyrrole and poly(diaminonaphthalene), PDAN, can collect both inorganic and organic Hg species via complexation, as supported by Infrared and Raman as well as X-ray photoelectron spectroscopy analyses. Despite its advantages, adsorption is slow due to diffusion limitations.

Proper surface functionalization improves the ability for capturing CH₃Hg⁺ significantly, and various approaches such as magnetic nanoparticle-based systems can help address the difficulty in collecting spent nanostructured adsorbents. However, these nanostructures cannot be easily regenerated for future use. The chemical or the combination of chemical and physical procedures required to reduce absorbed Hg species generate large volumes of chemical waste and consumes energy.

Subsequent treatment of collected Hg contaminants is also an important task. Chemical reduction consumes a large amount of chemicals and generates a significant amount of secondary waste. For chemical reduction, SnCl₂ and NaBH₄ have been employed to reduce Hg²⁺ at room temperature. CH₃Hg⁺, however, must be first converted to “reducible” Hg²⁺. UV-irradiation (UV) or ultrasonication (US) in the presence of a reducing agent can reduce CH₃Hg⁺ into a vapor Hg(0) form. This procedure is both a chemically and energy intensive process. Another common method to sequester and reduce CH₃Hg⁺ involves ethylation followed by pyrolytic decomposition, which is also chemically intensive and costly.

Accordingly, there is a need for a water decontamination and recovery system and method is that is inexpensive, reliable, scalable and reusable.

### BRIEF SUMMARY

Current approaches for removing toxins for water restoration typically involve the addition of different chemicals (small molecules or polymers) into the wastewater to trap metal ions or to react with harmful organic waste. However, these approaches may generate secondary pollution by chemical absorbers that are hard to collect; provide inadequate removal of toxins due to poor selectivity and/or affinity; and experience low-efficiency due to the inability of metals to access binding sites in a 3D porous structure. There is also no straightforward means of regeneration and no way to recover the seized metal species with current approaches.

In comparison, the present technology provides an electrochemically regeneratable platform capable of treating all soluble heavy metal species. The platform utilizes a 3D conductive hierarchical electrode that offers three tiered (macro-, micro- and nano-scale) continuous porous structures with minimum tortuosity. The system is regeneratable at high throughput and has low energy consumption offering a new solution for wastewater treatment.

The toxicity of mercury in humans and to the environment is well established. One priority of industry and governments is the effective removal of Hg, in particular organomercury such as CH₃Hg⁺ from liquid waste. Mercury removal is used to illustrate the utility of the apparatus and methods. However, the system can be used for separation of other heavy metals from fluids as well.

Generally, for heavy metal separations, the electrochemical platform first concentrates the heavy metal contaminants like Hg via complexation. The captured Hg species is then reduced via an electrochemical method into micro-droplets of Hg(0) which can be readily aggregated and collected. The 3D, conductive, hierarchical platform structure can be reused readily through electrochemical regeneration. The mercury on the cathode can be reduced and thus the cathode can be regenerated. On the other hand, oxyanions such as nitrates and nitrites on the anode can be separated and converted into nontoxic products if needed.

The platform is based on a mechanically robust, conductive 3D scaffold material that offers non-obstructive nanoscale channels that may be fabricated by direct growth of multiwalled carbon nanotubes (MWCNTs), nanofibers or nanowires on microfiber strands forming a carbon cloth. Alternatively, carbon aerogel or electropolymerization of conductive polymer nanowires on carbon cloth followed by pyrolysis can be employed to produce a conductive scaffold with high surface area.

A thin layer of polymer with optional engineered functional groups for effective sequestration of Hg²⁺ and CH₃Hg⁺ is then uniformly grafted on the entire 3D carbon surface for Hg and other heavy metal capture. While Hg²⁺ will be reduced galvanostatically due to the reducing propensity of the polymer, cathodic reduction will convert CH₃Hg⁺ into Hg(0). An electrical bias can accelerate the collection process of charged species.

The preferred platform is a three-tiered hierarchical porous structure that is composed of micropores formed by woven carbon cloth, nanopores formed after MWCNT growth and mesopores formed by the application of the polymer after leaching unreacted species, affording facile ion capture.

The polymer covered structure offers a large surface area that is mechanically robust and electrically conductive. In one preferred embodiment, the entire 3D structure is uniformly decorated with poly(diaminonaphthalene), PDAN. The —N⁺(CH₃)³ functionalized PDAN is also capable of sequestering Cl⁻ and nitrate (NO⁻³) and the diarylamine ladder structure can capture Hg²⁺ and other heavy metals. Furthermore, the capture material can be regenerated and metals such as pure Hg can be recycled for future use.

The platform and system for concentration, reduction and regeneration is also complemented by cell designs for optimizing advective and diffusive mass transport for high throughput and minimization of parasitic resistance. To improve the throughput, the cell can have a two parallel electrode configuration so that the —N⁺(CH₃)³ functionalized PDAN may have a positive bias and the other end of the diarylamine ladder structure may be negatively biased. Significantly, absorbers are covalently anchored.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE SEVERAL VIEWS OF THE DRAWINGS

The technology described herein will be more fully understood by reference to the following drawings which are for illustrative purposes only:

FIG. 1 is a schematic block system diagram of a method for fabricating a 3D hierarchical, conductive carbon-based electrode element according to one embodiment of the technology.

FIG. 2A is a 1,5 DAN and corresponding polymer chemical structures and in the linear form for Hg incorporation according to one embodiment of the presented technology.

FIG. 2B is a 1,8 DAN and corresponding polymer chemical structures in the ladder form before and after metal sequestration according to one embodiment of the presented technology.

FIG. 3 is a cyclic voltammetry analysis graph showing two different structure forms (0.5 MH₂SO₄, 10 mV/sec) of 1,5 DAN and corresponding polymer linear polymer and 1,8 DAN and corresponding ladder polymer.

FIG. 4 is a schematic cross-sectional view of polymer coated carbon nanotube carbon cloth and a polymer structure after complexation with CH₃Hg⁺ ions.

FIG. 5 is a graph of the effects of equilibration time on the removal of Hg²⁺ and CH₃Hg⁺ ions by PANI according to one embodiment of the technology.

FIG. 6 is a schematic diagram of a treatment cell utilizing flow-through bipolar electrode stack for advection accelerated mass transfer.

### DETAILED DESCRIPTION

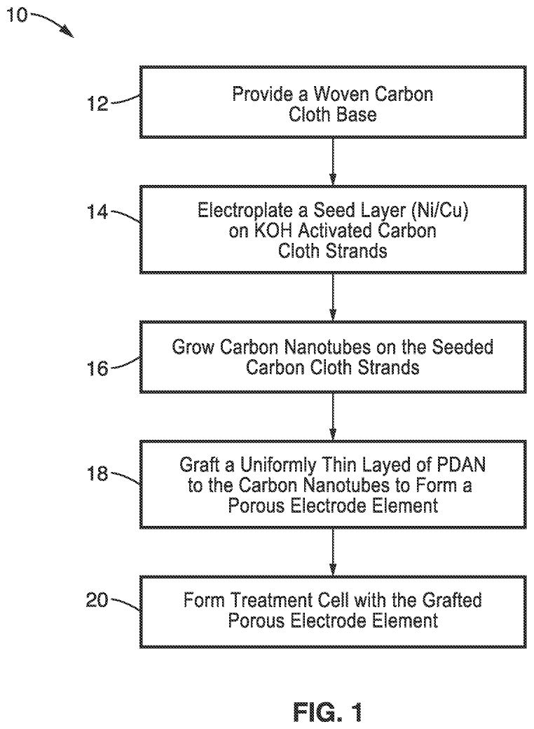

Referring more specifically to the drawings, for illustrative purposes, embodiments of apparatus, system and methods for heavy metal contaminant removal from fluids are generally shown. Several embodiments of the technology are described generally in FIG. 1 to FIG. 6 to illustrate the characteristics and functionality of the devices, methods and systems. It will be appreciated that the methods may vary as to the specific steps and sequence and the systems and apparatus may vary as to structural details without departing from the basic concepts as disclosed herein. The method steps are merely exemplary of the order that these steps may occur. The steps may occur in any order that is desired, such that it still performs the goals of the claimed technology.

Turning now to FIG. 1, one embodiment of a method 10 for fabricating porous electrode collection elements for use in water treatment cells is shown schematically and is used to illustrate the technology.

At block 12 of FIG. 1, a base of a cloth of woven of strands of carbon fibers or microfibers is provided. The weave of the carbon cloth base can be of carbon strands of selected diameters that will permit a controllable porosity between the fibers. Preferred strands forming the carbon cloth are preferably microfibers with a diameter of between about 5 microns and about 10 microns. While 10 μm microfiber strands are preferred, larger or smaller diameter strands of equal or mixed diameters can be used to weave the carbon cloth at block 12.

In other embodiments, a weave of carbon coated strands of conductive materials such as silicon nanowires are used in the base for settings where an increase in strength over that of carbon only strands is desired. Weaves of carbon coated microfibers may be able to handle increased fluid loads/pressures over carbon only strands forming the cloth base structure.

In the embodiment of FIG. 1, the surfaces of the strands forming the carbon cloth base are activated with KOH and a seed layer of Ni or Cu or other growth catalyst is applied to the strands at block 14 in preparation for the growth of carbon nanotubes, carbon nanofibers or carbon nanowires at block 16. Alternatively, conductive carbon aerogels can be used as a scaffold for carbon nanotube production from the surface of the carbon cloth.

Multi-walled carbon nanotubes (CNTs) or other 1D structures are then grown conformally on the surfaces of the cloth base at block 16. This creates a well-defined and mechanically robust 3D structure with unobstructed microchannels and nanochannels. It is possible to grow carbon nanotubes at high densities CNTs for high-loading of absorbent through adjusting growth conditions and catalyst composition.

The seed-mediated growth approach can be used to grow carbon nanotubes, carbon nanofibers and other 1D nanostructures with uniform diameter and tunable density and morphologies on a variety of surfaces at block 16. Scanning electron micrograph (SEM) images can confirm that multi-walled CNTs emanate from the surfaces of individual carbon microfibers that are interwoven into carbon cloth.

Electrochemical analysis has shown a 20-fold increase in electrochemical surface area after carbon nanotube formation. Multi-walled CNTs are chosen due to the combination of large synthesis latitude and excellent mechanical properties with superb electrical conductivity.

The entire 3D real estate of the platform is then uniformly grafted with a thin layer of poly(diaminonaphthalene) (PDAN) or another suitable polymer in the step of block 18 of FIG. 1. Although PDAN is preferred, other N-containing polymers such as polyaniline, PANI and polypyrrole can be used to effectively collect both inorganic and organic Hg species and other heavy metals via complexation.

Electrografting of PDAN, for example, can form a conformably grafted thin layer on the carbon nanotubes and carbon cloth. Both the thickness and morphology of the applied layer can be rationally controlled. Surfactants may also be employed as a template to create an enhanced porous structure.

Accordingly, in one embodiment, a three-tiered hierarchical porous structure, composed of micropores formed by woven carbon cloth, nanopores formed after MWCNT growth and mesopores formed by the polymer after leaching unreacted species is generated to insure sufficient permeability. Unlike carbon aerogels, the system based on carbon cloth will be mechanically robust, more conductive and less prone to clogging.

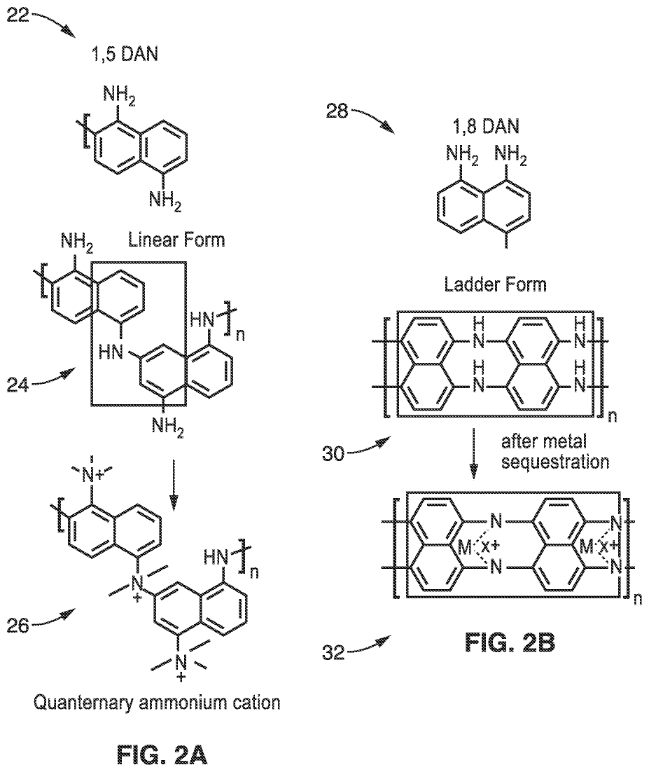

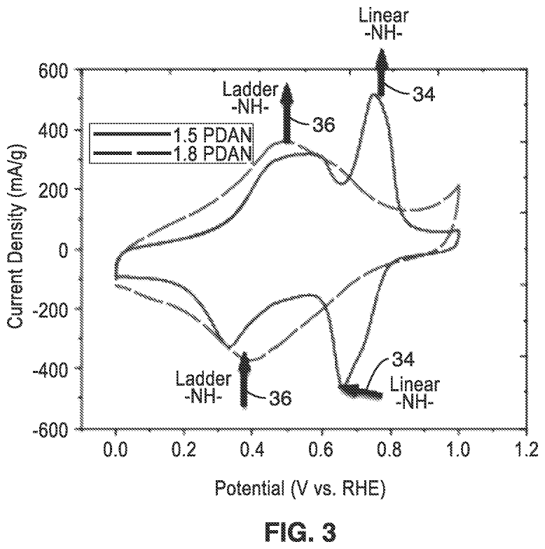

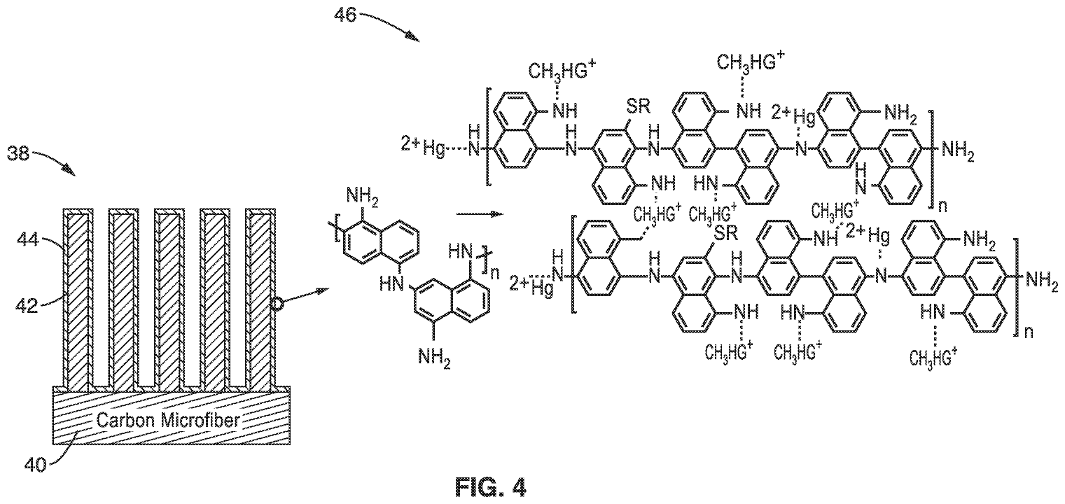

Electrochemical analysis indicates that both diarylamine in linear and ladder forms can be observed as illustrated in FIG. 3 and FIG. 2A and FIG. 2B. To capture Cl⁻ and NO³⁻, in one embodiment, 1,5 DAN is electropolymerized in an acid media to graft 1,5 PDAN onto MWCNTs as shown in FIG. 2A and FIG. 4.

As seen in FIG. 2A, the 1,5 DAN polymer 22 is grafted in a linear form 24 that can be further modified. Both primary and secondary amine groups of the structure 26, can be further functionalized to —N⁺(CH₃)₃ groups via exhaustive methylation or thiolation as indicated in FIG. 2A to enable absorption of nitrate as well as chlorine ions. Unfunctionalized diarylamine can also capture metal ions.

To increase absorption of metal ions such as Hg²⁺, in one embodiment; 1,8 PDAN polymers 28 is grafted in latter form 30 as shown in FIG. 2B. The ladder diarylamine group is known to “trap” metal ions including Hg²⁺ as illustrated in the structure 32 of FIG. 2B.

The final coated porous electrode structure 38 is shown schematically in cross-section in FIG. 4, with nanotubes on only one side of the strand to illustrate the structure. The carbon microfiber strand 40 with nanotubes 42 or other carbon structures are coated with a thin layer of polymer 44 such as PDAN. Additionally, as shown in FIG. 4, the diarylamine groups 46 of the polymer coating 44 of the porous electrode element 38 can complex with CH₃Hg⁺ as well as Hg²⁺ ions.

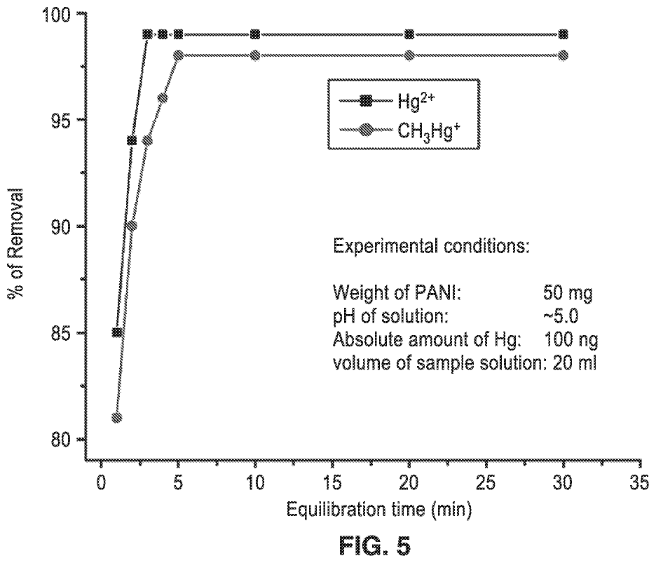

The effect of equilibration time on the removal of Hg²⁺ and CH₃Hg⁺ by PANI is shown in FIG. 5. One lone pair of electrons on a nitrogen of the polymer can coordinate with Hg and other heavy metal compounds. PANI, which contains arylimine groups, can be used to adsorb Hg²⁺ from an aqueous solution. It can be also used for pre-concentration of CH₃Hg⁺ species. At pH>6, >95% uptake of CH₃Hg⁺ has been achieved within 5 min as demonstrated by the data in FIG. 5. Diaminonaphthalene, DAN, can be viewed as two fused anilines as seen in FIG. 2A and FIG. 2B. It should more effectively capture both organic and inorganic Hg species as it can form a more stable complex between one Hg species and two N ligands. 97% uptake and about 394 mg/g absorbing capacity for an initial concentration of Hg²⁺ of 4 mM after 24 hours at 30° C. was reported for PDAN that was not optimized for Hg capture.

The chemical structure of the polymer can be tuned by pH (protonation) as well as the applied oxidation potential during the polymerization. In addition to diverse chemical structures, tunable morphology and high affinity for absorbing Hg and other heavy metal species, the preferred polymer offers excellent thermal stability and thus allows use in harsh thermal and chemical processes.

Since PANI can be thiolated by soaking in mercaptan, it is also possible to substitute sulfur groups on aromatic rings in PDAN using this approach. If needed, the film can be exposed to hydrogen sulfide to generate —SH functional groups. This newly functionalized surface is capable of forming strong Hg—S bonds, for example. Although this will help to capture Hg species, the Hg—S bonds might be too strong for reduction in some settings.

The sheets of porous, 3D conductive carbon-based porous electrode that are produced can be incorporated into treatment cell designs that are capable of concentrating and reducing heavy metal ion species from fluids.

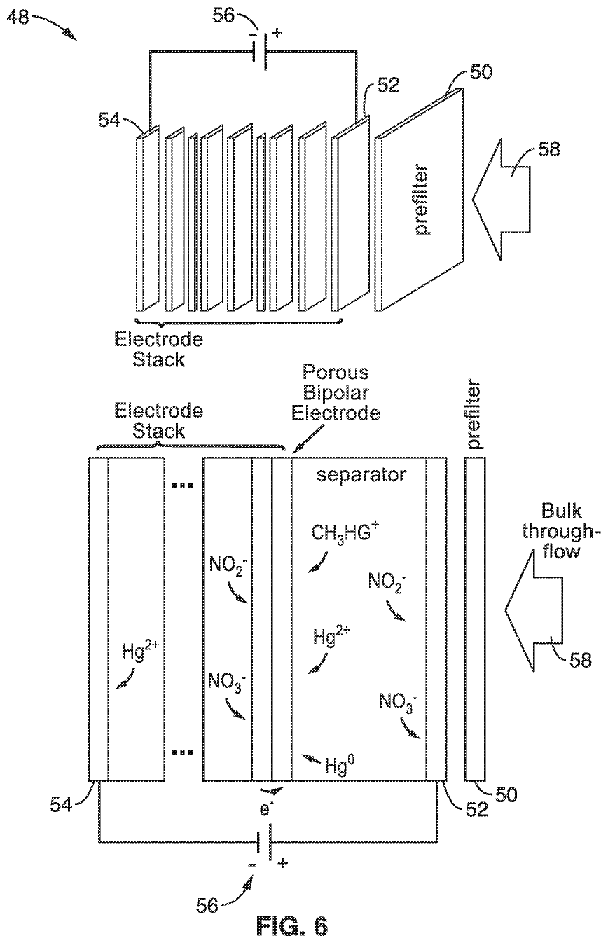

One embodiment of a treatment cell 48 utilizing a flow-through electrode stack for advection accelerated mass transfer is shown schematically in FIG. 6. In this embodiment, the cell 48 is formed from a stack of flow through porous bipolar electrodes 60. The inner electrodes 60 in this stack are bipolar. Cation and anion capturing electrode layers may be mated together, reducing resistance associated with electronic conduction and simplifying cell construction. The outer anode 52 and cathode 54 electrodes are monopolar, converting ionic to electronic current and interfacing to the power supply 56. Potential fouling of the cell is minimized by a filter 50 prefiltering the incoming water 58 to remove suspended micro sized particles. The stack geometry in this embodiment allows operation at higher voltages and lower currents than with single electrode pairs, which minimizes electrical subsystem costs, and facilitates a compact cell design with low superficial flow velocity and high removal capacity.

As a result, anions such as NO³⁻, Cl⁻ and cations such as Hg²⁺ and Pb²⁺ can be captured and removed from underground water. The anode 52 can be —N⁺(CH₃)³ functionalized PDAN which is capable of sequestering oxyanions such as nitrate (NO₃⁻) while the cathode can also be PDAN that is replete with diarylamine groups, which can complex with Hg²⁺ and CH₃Hg⁺as depicted in the detail of FIG. 6. The system will also be resistant to Cl⁻ attack.

Cell designs that optimize advective and diffusive mass transport to maximize throughput and minimize parasitic resistance for fast charge transfer and low energy loss are preferred as shown in FIG. 6.

Adsorbents provide an effective means to attack heavy metal contamination in aqueous solutions, and electrochemical methods can convert the metals into more benign forms for disposal or recycling. However, both approaches pose transport limitations. These limitations arise from the requirements that contaminant ions diffuse to the adsorbent surface and charges be transported to the active site. Diffusion of the contaminant ions to the active surface is generally the rate controlling step in the treatment process.

Conduction of charge further imposes penalties in terms of energy consumption and parasitic electrochemical processes that may reduce the effectiveness of metal reduction. Both transport limitations suggest the need to minimize transport distances for chemical species and charge, which translates to a preference for minimum electrode thicknesses and separations in electrochemical cells in general. However, these parameter choices also limit electrode capacity and feed flow resistance, respectively. Therefore, the use the tailored 3D meso- and micro-structure of the electrode design takes advantage of convective flow that is an additional transport mechanism within the electrode structure. Utilizing the open structure of the carbon cloth substrate, it is possible to direct feedwater flow 58 normal to the electrode plane as shown in FIG. 6. This results in advection of the contaminant species to the active sites within the electrode and reduces the diffusion length to the scale of the boundary layer in the porous structure (e.g. <1 μm). The reduction in diffusion length dramatically increases the rate of adsorption and throughput of the cell.

Accordingly, the 3D hierarchical conductive carbon-based electrode is capable of concentrating and reducing Hg species and other metal ions. Absorbent moieties offered by PDAN that are covalently coated on the surface of a 3D carbon scaffold, for example, can form complexes with both CH₃Hg⁺ and Hg²⁺. The local concentration of the Hg species and the consequent adsorption rate at the electrode will increase by applying a negative potential bias. Using an electrochemical step, both species can be reduced into Hg(0) droplets that can be extracted from the electrode for store or recycling. After the removal of Hg, the electrode can be then regenerated. No chemicals are needed during either the sequestration process or the regeneration process.

The technology described herein may be better understood with reference to the accompanying examples, which are intended for purposes of illustration only and should not be construed as in any sense limiting the scope of the technology described herein as defined in the claims appended hereto.

### Example 1

To demonstrate the functionality of the system and methods, 1,5 PDAN and 1,8 PDAN polymer grafted carbon nanotubes on carbon cloth electrode element structures and treatment cells were fabricated according to the scheme of FIG. 1 and then tested. Multiwalled carbon nanotubes (MWCNTs) were grown on the carbon cloth and observed by scanning electron microscope (SEM) imaging. For comparison, a carbon aerogel and electro-polymerization of conductive polymer nanowires on carbon cloth followed by pyrolysis were used to produce carbon nanostructures on the carbon cloth strands as conductive scaffolds with high surface area.

The seed-mediated growth methods were also used to grow carbon nanofibers, nanowires, nanorods and other 1D nanostructures with uniform diameter and tunable density and morphologies on a variety of surfaces.

A thin layer of various types of polymers with engineered functional groups for effective sequestration of Hg²⁺ and CH₃Hg⁺ was uniformly grafted on the entire 3D surface of the test nanotube encased carbon cloth for evaluation of Hg capture.

The scanning electron micrograph (SEM) images displayed multi-walled CNTs emanating from the surfaces of individual carbon microfibers that were interwoven into carbon cloth. Electrochemical analysis showed a 20 fold increase in electrochemical surface area after CNT formation. Multi-walled CNTs were chosen due to the combination of large synthesis latitude and excellent mechanical properties with superb electrical conductivity. The as-synthesized 3D structure could be preserved during the subsequent polymerization process to conformably coat the polymer absorbing layer. The density of CNTs could also be controlled by adjusting growth conditions and catalyst composition for producing high-loading of absorbents.

Accordingly, a three-tiered hierarchical porous structure, composed of micropores formed by woven carbon cloth, nanopores formed after MWCNT growth and mesopores formed by polymer after leaching unreacted species, was generated to illustrate the fabrication methods.

### Example 2

To further demonstrate the operational principles of the apparatus and methods, different polymer layers and different polymer surface functionalization's were evaluated. To generate ample imine and amine groups, a ladder structure was formed by using 1,5 DAN instead of 1,8 DAN. The grafted polymer thickness and resulting amount of absorbing species was adjusted and consequently the electrochemical surface area was tuned to demonstrate the adaptability of the system. For facile collection of reduced Hg(0), adjustments in the polymerization conditions produced an increase polymer surface roughness or porosity which was illustrated by SEM imaging.

Tuning of the polymer chemical structure was also demonstrated by incremental adjustments to pH (protonation) as well as by an applied oxidation potential during the polymerization.

Likewise, substitution of sulfur groups on the aromatic rings in PDAN was demonstrated with exposure to mercaptan. Sulfur functional groups were also generated by exposure to hydrogen sulfide.

The functionalized materials were also evaluated for their ability to complex and effectively capture both organic and inorganic Hg species. It was demonstrated that there was a 97% uptake and about 394 mg/g absorbing capacity for an initial concentration of Hg²⁺of 4 mM after 24 hours at 30° C. for PDAN for Hg capture and 95% uptake of CH³Hg⁺ has been achieved within 5 minutes at pH>6.

### Example 3

An important aspect of the electrochemical platform is the capability of regeneration and release of the sequestered heavy metals. As shown above, the energy efficient electrochemical platform can concentrate mercury contaminants via complexation of one Hg species with two N ligands and then convert the ionic Hg species into elemental liquid Hg(0) micro-droplets which can be readily aggregated and collected. At the same time, oxoanions could be collected and converted into non-toxic waste as needed. As a result, the entire system can be regenerated and used for continuous cleanup. The integrated approach to collect, monitor, reduce, and recycle/store mercury from solution addresses key challenges in wastewater treatment.

For example, PANI can have the reduction propensity to reduce Ag⁺ (0.8 V vs. H₂/H⁺) to Ag(0) galvanostatically. Analogously, Hg²⁺ (0.85 V vs. H₂/H⁺) can be reduced after incorporation in PDAN. However, CH₃Hg⁺ is more challenging but it can be reduced electrochemically with the use of a gold (Au) coated planar carbon electrode.

To reduce concentrated Hg and regenerate the 3D electrodes, an electrochemical method was used with a non-catalytic approach. The high interfacial intension of water/mercury (0.4 N/m) facilitates extraction from the electrode. There is a strong capillary force driving expulsion of the elemental Hg from the porous structure. In-situ capillary pumping generated by nanoscale channels in the new 3D structure facilitated continuous elemental Hg collection. Separation of Hg(0) micro-droplets from water was straightforward by agitation or sonication to agglomerate and followed by decanting since Hg(0) is immiscible and 13 times denser than water.

In one embodiment, an optional electrocatalytic species was incorporated into the polymer layer to mitigate H₂ evolution. For example, incorporation of electrocatalytically active Au nanoparticles into PDAN will further catalyze the reduction of CH₃Hg⁺.

The very low reduction potential of Hg²⁺ and relatively high reduction potential of CH₃Hg⁺ allows the selective removal of inorganic and organic Hg species. The active “absorbing” sites of the electrode may also accumulate other cationic species. Due to different affinities of metal ions with ligands, after removal of Hg²⁺, polarity reversal allows expulsion of most of interfering cations (back to water). After that, a relatively large negative reduction potential was used to reduce CH₃Hg⁺ into Hg(0). An electrochemical means (e.g., EIS) might allow monitoring the accumulation of Hg to determine when regeneration should be performed.

From the description herein, it will be appreciated that that the present disclosure encompasses multiple embodiments which include, but are not limited to, the following:

1. A heavy metal ion adsorber material, comprising: (a) a scaffold of multiple interwoven carbon strands, the strands having an outer surface; (b) a plurality of 1D conductive nanostructures mounted to the outer surface of each carbon strand; and (c) a coating of at least one polymer on outer surfaces of the nanostructures and the carbon strands.

2. The adsorber of any preceding or following embodiment, wherein the scaffold comprises a carbon cloth of interwoven carbon strands with a diameter of between 5 μm and 10 μm.

3. The adsorber of any preceding or following embodiment, wherein the 1D nanostructures are selected from the group of nanostructures consisting of multiwalled carbon nanotubes, carbon nanofibers and carbon nanowires.

4. The adsorber of any preceding or following embodiment, wherein the polymer is a polymer selected from the group of polymers consisting of polyaniline, PANI, and polypyrrole.

5. The adsorber of any preceding or following embodiment, wherein the polymer is a polymer selected from the group of polymers consisting of poly(1,5-diaminonaphthalene) and poly(1,8-diaminonaphthalene).

6. The adsorber of any preceding or following embodiment, the polymer coating further comprising functionalized amine groups from exhaustive methylation.

7. The adsorber of any preceding or following embodiment, the scaffold further comprising an electrical contact, the contact configured to connect to an electrical power source.

8. A method for fabricating an adsorber material, the method comprising: (a) fabricating a one, two or three-dimensional carbon scaffold; (b) forming a plurality of 1D nanostructures on the carbon scaffold to form a modified carbon scaffold structure; and (c) applying a thin layer of a N-containing conductive polymer on outer surfaces of the modified carbon scaffold structure.

9. The method of any preceding or following embodiment, wherein the carbon scaffold comprises a carbon cloth of interwoven carbon microfiber strands having a diameter of between of between 5 μm and 10 μm.

10. The method of any preceding or following embodiment, further comprising: activating the carbon cloth strands with KOH; and electroplating a seed layer of a catalyst for carbon nanotube growth.

11. The method of any preceding or following embodiment, wherein the carbon scaffold comprises a carbon aerogel.

12. The method of any preceding or following embodiment, wherein the 1D nanostructures are selected from the group of nanostructures consisting of multiwalled carbon nanotubes, carbon nanofibers and carbon nanowires.

13. The method of any preceding or following embodiment, wherein the N-containing polymer is a polymer selected from the group of polymers consisting of polyaniline, PANI, and polypyrrole.

14. The method of any preceding or following embodiment, wherein the N-containing polymer is a polymer selected from the group of polymers consisting of poly-1,5-diaminonaphthalene, poly-1,8-diaminonaphthalene, and combinations thereof.

15. The method of any preceding or following embodiment, further comprising chemically modifying the polymer layer to produce a modified carbon scaffold structure with a functionalized polymer outer surface.

16. The method of any preceding or following embodiment, wherein the chemical modification of the polymer layer comprises thiolation of polymer amines.

17. The method of any preceding or following embodiment, wherein the chemical modification of the polymer layer comprises or exhaustive methylation of polymer amines.

18. The method of any preceding or following embodiment, further comprising: leaching unreacted polymer species; wherein a three-tiered hierarchical porous structure is produced, comprising micropores formed by woven carbon cloth, nanopores formed after carbon nanotube growth and mesopores formed by polymer after leaching unreacted species.

19. A fluid treatment cell apparatus, the apparatus comprising: (a) an anode of a carbon scaffold modified with a plurality of 1D carbon nanostructures coated with a polymer; (b) a cathode of a carbon scaffold modified with 1D carbon nanostructures coated with a polymer; and (c) a voltage source electrically coupled with the anode and cathode.

20. The apparatus of any preceding or following embodiment, further comprising: (a) a stack of flow-through electrodes with an electrode plane; and (b) a housing configured to direct fluid in a direction normal to the electrode plane allowing advection of the contaminant species to active sites within the electrode stack and reduces the diffusion length to the scale of the boundary layer in the porous scaffold structure.

21. The apparatus of any preceding or following embodiment, wherein the carbon scaffold comprises a carbon cloth of interwoven carbon strands with a diameter of about 10 μm.

22. The apparatus of any preceding or following embodiment, wherein the 1D nanostructures are selected from the group of nanostructures consisting of multiwalled carbon nanotubes, carbon nanofibers and carbon nanowires.

23. The apparatus of any preceding or following embodiment, wherein the polymer is a polymer selected from the group of polymers consisting of polyaniline, PANI, polypyrrole, poly(1,5-diaminonaphthalene) and poly(1,8-diaminonaphthalene).

24. The apparatus of any preceding or following embodiment, the polymer coating further comprising functionalized amine groups functionalized with a thiol group or a methyl group.

25. A method for decontaminating a fluid, the method comprising:

(a) exposing a flow of fluid to a treatment cell apparatus, comprising: (1) an anode of a carbon scaffold modified with 1 D carbon nanostructures coated with a functionalized polymer; (2) a cathode of a carbon scaffold modified with 1 D carbon nanostructures coated with a functionalized polymer; and (3) a voltage source electrically coupled with the anode and cathode; (b) regenerating the electrodes by releasing adsorbed contaminants; and (c) collecting the released contaminants.

26. The method of any preceding or following embodiment, the treatment cell apparatus further comprising: (a) a stack of flow-through electrodes with an electrode plane; and (b) a housing configured to direct fluid in a direction normal to the electrode plane allowing advection of the contaminant species to active sites within the electrode stack and reduces the diffusion length to the scale of the boundary layer in the porous scaffold structure.

27. The method of any preceding or following embodiment, wherein the anode can absorb and regenerate metal cations selected from the group of cations consisting of Hg⁺, Hg²⁺, Ag⁺, Fe²⁺, Fe³⁺ and Cr³⁺.

28. The method of any preceding or following embodiment, wherein the cathode can absorb and denature anions present within the fluid.

29. The method of any preceding or following embodiment, wherein the voltage source can accelerate reactions.

As used herein, the singular terms “a,” “an,” and “the” may include plural referents unless the context clearly dictates otherwise. Reference to an object in the singular is not intended to mean “one and only one” unless explicitly so stated, but rather “one or more.”

As used herein, the term “set” refers to a collection of one or more objects. Thus, for example, a set of objects can include a single object or multiple objects.

As used herein, the terms “substantially” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. A heavy metal ion adsorber material, comprising:
(a) a scaffold of multiple interwoven carbon strands, said strands having an outer surface;
(b) a plurality of 1D conductive nanostructures mounted to the outer surface of each carbon strand; and
(c) a coating of at least one polymer on outer surfaces of said nanostructures and said carbon strands.

2. The adsorber of claim 1, wherein said scaffold comprises a carbon cloth of interwoven carbon strands with a diameter of between 5 μm and 10 μm.

3. The adsorber of claim 1, wherein said 1D nanostructures are selected from the group of nanostructures consisting of multiwalled carbon nanotubes, carbon nanofibers and carbon nanowires.

4. The adsorber of claim 1, wherein said polymer is a polymer selected from the group of polymers consisting of polyaniline, PANI, and polypyrrole.

5. The adsorber of claim 1, wherein said polymer is a polymer selected from the group of polymers consisting of poly(1,5-diaminonaphthalene) and poly(1,8-diaminonaphthalene).

6. The adsorber of claim 1, said polymer coating further comprising functionalized amine groups from exhaustive methylation.

7. The adsorber of claim 1, said scaffold further comprising an electrical contact, said contact configured to connect to an electrical power source.

8. A method for fabricating an adsorber material, the method comprising:
(a) fabricating a one, two or three-dimensional carbon scaffold;
(b) forming a plurality of 1D nanostructures on the carbon scaffold to form a modified carbon scaffold structure; and
(c) applying a thin layer of a N-containing conductive polymer on outer surfaces of the modified carbon scaffold structure.

9. The method of claim 8, wherein said carbon scaffold comprises a carbon cloth of interwoven carbon microfiber strands having a diameter of between of between 5 μm and 10 μm.

10. The method of claim 9, further comprising:
activating carbon cloth strands with KOH; and
electroplating a seed layer of a catalyst for carbon nanotube growth.

11. The method of claim 8, wherein said carbon scaffold comprises a carbon aerogel.

12. The method of claim 8, wherein said 1D nanostructures are selected from the group of nanostructures consisting of multiwalled carbon nanotubes, carbon nanofibers and carbon nanowires.

13. The method of claim 8, wherein said N-containing polymer is a polymer selected from the group of polymers consisting of polyaniline, PANI, and polypyrrole.

14. The method of claim 8, wherein said N-containing polymer is a polymer selected from the group of polymers consisting of poly-1,5-diaminonaphthalene, poly-1,8-diaminonaphthalene, and combinations thereof.

15. The method of claim 8, further comprising chemically modifying the polymer layer to produce a modified carbon scaffold structure with a functionalized polymer outer surface.

16. The method of claim 15, wherein said chemical modification of said polymer layer comprises thiolation of polymer amines.

17. The method of claim 15, wherein said chemical modification of said polymer layer comprises or exhaustive methylation of polymer amines.

18. The method of claim 8, further comprising:
leaching unreacted polymer species;
wherein a three-tiered hierarchical porous structure is produced, comprising micropores formed by woven carbon cloth, nanopores formed after carbon nanotube growth and mesopores formed by polymer after leaching unreacted species.

19. A fluid treatment cell apparatus, the apparatus comprising:
(a) an anode of a carbon scaffold modified with a plurality of 1 D carbon nanostructures coated with a polymer;
(b) a cathode of a carbon scaffold modified with 1 D carbon nanostructures coated with a polymer; and
(c) a voltage source electrically coupled with the anode and cathode.

20. The apparatus of claim 19, further comprising:
(a) a stack of flow-through electrodes with an electrode plane; and
(b) a housing configured to direct fluid in a direction normal to the electrode plane allowing advection of the contaminant species to active sites within the electrode stack and reduces the diffusion length to the scale of the boundary layer in the porous scaffold structure.

21. The apparatus of claim 19, wherein said carbon scaffold comprises a carbon cloth of interwoven carbon strands with a diameter of about 10 μm.

22. The apparatus of claim 19, wherein said 1D nanostructures are selected from the group of nanostructures consisting of multiwalled carbon nanotubes, carbon nanofibers and carbon nanowires.

23. The apparatus of claim 19, wherein said polymer is a polymer selected from the group of polymers consisting of polyaniline, PANI, polypyrrole, poly(1,5-diaminonaphthalene) and poly(1,8-diaminonaphthalene).

24. The apparatus of claim 19, said polymer coating further comprising functionalized amine groups functionalized with a thiol group or a methyl group.

25. A method for decontaminating a fluid, the method comprising:
(a) exposing a flow of fluid to a treatment cell apparatus, comprising:
(1) an anode of a carbon scaffold modified with 1D carbon nanostructures coated with a functionalized polymer;
(2) a cathode of a carbon scaffold modified with 1D carbon nanostructures coated with a functionalized polymer; and
(3) a voltage source electrically coupled with the anode and cathode;
(b) regenerating the electrodes by releasing adsorbed contaminants; and
(c) collecting the released contaminants.

26. The method of claim 25, said treatment cell apparatus further comprising:
(a) a stack of flow-through electrodes with an electrode plane; and
(b) a housing configured to direct fluid in a direction normal to the electrode plane allowing advection of the contaminant species to active sites within the electrode stack and reduces the diffusion length to the scale of the boundary layer in the porous scaffold structure.

27. The method of claim 25, wherein said anode can absorb and regenerate metal cations selected from the group of cations consisting of Hg⁺, Hg²⁺, Ag⁺, Fe²⁺, Fe³⁺ and Cr³⁺.

28. The method of claim 25, wherein said cathode can absorb and denature anions present within the fluid.

29. The method of claim 25, wherein said voltage source can accelerate reactions.
